(19) United States
(12) Patent Application Publication
(10) Pub. No.: US 2015/0046548 A1
(43) Pub. Date: Feb. 12, 2015

(54) TERMINAL AND METHOD FOR REPRODUCING CONTENTS THEREOF, AND MASSAGE MANAGEMENT SYSTEM AND METHOD FOR PROVIDING MESSAGE RELATED TO CONTENTS

(71) Applicant: Korea Advanced Institute of Science and Technology, Daejeon (KR)

(72) Inventors: Jae-Gil Lee, Daejeon (KR); Juyup Sung, Daejeon (KR)

(21) Appl. No.: 14/344,201

(22) PCT Filed: Dec. 4, 2012
(86) PCT No.: PCT/KR2012/010430

§ 371 Date: Mar. 11, 2014

(30) Foreign Application Priority Data
Mar. 14, 2012 (KR) KR 1020120026284

(51) Int. Cl. H04L 12/58; H04L 29/06

(52) U.S. Cl. CPC H04L 51/046; H04L 65/4069
USPC 709/206

(57) ABSTRACT

A method for reproducing content by a terminal includes reproducing content received from a content providing system, receiving a first message through a user interface of the terminal while the content is being reproduced, and transmitting time information of the content at which the first message was input and the first message to a message management system.

### TECHNICAL FIELD

The present invention relates to a terminal, a method for reproducing (or playing) content thereof, a message management system, and a method for providing a content-related message thereof.

### BACKGROUND ART

As the communication technologies have been advanced, demand for interactive multimedia services have been on the rise. To meet the demand, techniques enabling a multimedia content providing system to provide information associated with multimedia content or user required information, while the multimedia content is being reproduced (or played) have been developed.

For example, while multimedia content is being played, if a user selects a particular position of a screen, the multimedia content providing system may provide stored information corresponding to the selected position. For example, in a case in which a particular position of the screen selected by the user indicates a book that the user is reading, the multimedia content providing system may provide information regarding the corresponding book together.

Even in this case, however, the user may merely passively obtain limited, stored information from the multimedia content providing system.

Thus, a method whereby users may obtain extensive additional information regarding corresponding multimedia content and conveniently share obtained additional information with someone else is required.

### DISCLOSURE

### Technical Problem

The present invention has been made in an effort to provide a terminal, a method for reproducing content thereof, a message management system, and a method for providing content-related information thereof.

### Technical Solution

An exemplary embodiment of the present invention provides a method for reproducing content by a terminal, including: reproducing content received from a content providing system: receiving a first message through a user interface of the terminal while the content is being reproduced; and transmitting time information of the content at which the first message was input and the first message to a message management system.

The method may further include: transmitting the time information of the content to the message management system at every predetermined period.

The method may further include: receiving a second message input through a different terminal through the message management system; and displaying the second message together with the content according to time information of content corresponding to the second message.

The method may further include: transmitting identification information of the terminal or identification information of the content to the message management system.

Another embodiment of the present invention provides a method for providing a content-related message by a message management system, including: receiving a first message regarding content input in a first time region from a first terminal that reproduces the content; storing the first message and information regarding the first time region; receiving information regarding a time region of content at predetermined periods from a second terminal that reproduces the content; and when the time region corresponds to the first time region, transmitting the first message to the second terminal.

The method may further include: receiving a second message regarding the content input in the second time region from the second terminal; storing the second message and information regarding the second time region; receiving information regarding a time region of content at predetermined periods from the first terminal or a third terminal that reproduces the content; and when the time region corresponds to the second time region, transmitting the second message to the first terminal or the third terminal.

Yet another embodiment of the present invention provides a terminal including: a content reproducing unit configured to reproduce content received from a content providing system; a user interface unit configured to receive a first message regarding the content from a user, while the content is being reproduced; and a transceiver unit configured to transmit time information of the content at which the first message was input and the first message to a message management system.

The transceiver unit may transmit the time information of the content to the message management system at every predetermined period.

The transceiver unit may receive a second message input through a different terminal from the message management system, and the terminal may further include an output unit configured to display the second message together with the content according to the time information of the content corresponding to the second message.

The output unit may include at least one of a first frame displaying the content, a second frame displaying the first message, and a third frame displaying the second message.

Still another embodiment of the present invention provides a message management system including: a transceiver unit configured to receive a first message regarding content from a first terminal that reproduces the content, transmit the first message to a second terminal that reproduces the content, and periodically receive time information of the content from the first terminal or the second terminal; a storage unit configured to store the first message and time information of the content corresponding to the first message; and a time management unit configured to monitor the periodically received time information of the content, and set the first message to be transmitted to the second terminal in a case in which the time information of the content received from the second terminal corresponds to time information of the first message received from the first terminal.

The storage unit may store at least one message as a list by content.

The lists may be arranged in order of time information of the content.

### Advantageous Effects

According to exemplary embodiments of the present invention, users may obtain multimedia content and content-related information together. In addition, users may positively participate in the process of configuring content-related information and share the content-related information with others.

### DESCRIPTION OF THE DRAWINGS

FIG. 1 is a block diagram illustrating a service environment to reproduce content according to an exemplary embodiment of the present invention.

FIG. 2 is a block diagram illustrating a message management system according to an exemplary embodiment of the present invention.

FIG. 3 is a block diagram illustrating a terminal according to an exemplary embodiment of the present invention.

FIG. 4 is a flow chart illustrating a method for providing content according to an exemplary embodiment of the present invention.

FIG. 5 is a flow chart illustrating a method for managing content-related message by the message management system according to an exemplary embodiment of the present invention.

FIGS. 6 through 9 are views illustrating an example specifically implementing a method for reproducing content by a terminal according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

In the present disclosure, multimedia content may be used mixed with content, video, multimedia video, and the like.

Hereinafter, a terminal, a method for reproducing content thereof, a message management system, and a method for providing content thereof according to exemplary embodiments of the present invention will be described in detail with reference to the accompanying drawings.

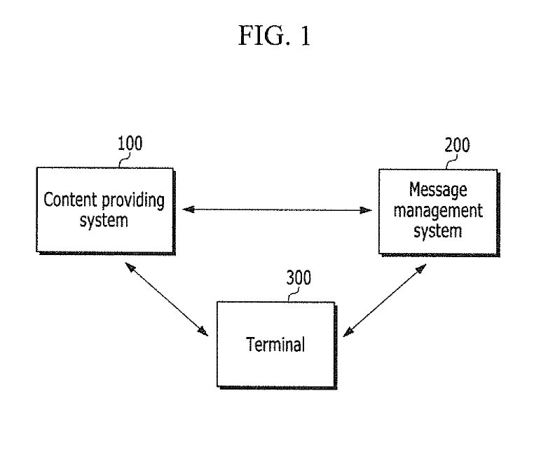

FIG. 1 is a block diagram illustrating a service environment to reproduce content according to an exemplary embodiment of the present invention.

Referring to FIG. 1, a service environment for content reproduction includes a content providing system 100, a message management system 200, and a terminal 300.

The content providing system 100 provides content to the terminal 300. Here, content may be provided in a streaming manner or downloading manner, and may be provided via a communication network or a broadcasting network. Content may be a video product such as an online lecture, a broadcast program, movie, and the like, for example. In the present disclosure, the content providing system 100 may be used mixed with a content providing server, a multimedia content providing system, a multimedia content providing server, a multimedia providing system, a multimedia providing server, a video providing system, a video providing server, and the like.

The message management system 200 receives a content-related message from the terminal 300, stores the same, and delivers the corresponding message to a different terminal. Here, the content-related message refers to a message input by a user through a user interface of the terminal with respect to the corresponding content, while the content is being reproduced. The content-related message may include, for example, a question regarding substance of content, answer to a user's question, additional information regarding substance of content, and the like. In the present disclosure, the message management system 200 may be mixedly used with a message management server, postings management system, postings management server, and the like.

The terminal 300 reproduces content received from the content providing system 100. The terminal 300 transmits the content-related message input from the user to the message management system 200. The terminal 300 displays the content-related message received from the message management system 200 together with content. To this end, a screen of the terminal 300 may be composed of a plurality of frames. Namely, the screen of the terminal 300 may be composed of a frame reproducing content, a frame displaying the content-related message input by the user, a frame displaying the content-related message received from the message management system 200, and the like. The terminal 300 may refer to any device including a function of reproducing multimedia content, such as a mobile terminal, a notebook computer, a desktop computer, a smartphone, an Internet protocol television (IPTV), a smart TV, and the like.

Hereinafter, the content providing method and the content-related information method by the content providing system 100, and the message management system 200 will be described in more detail.

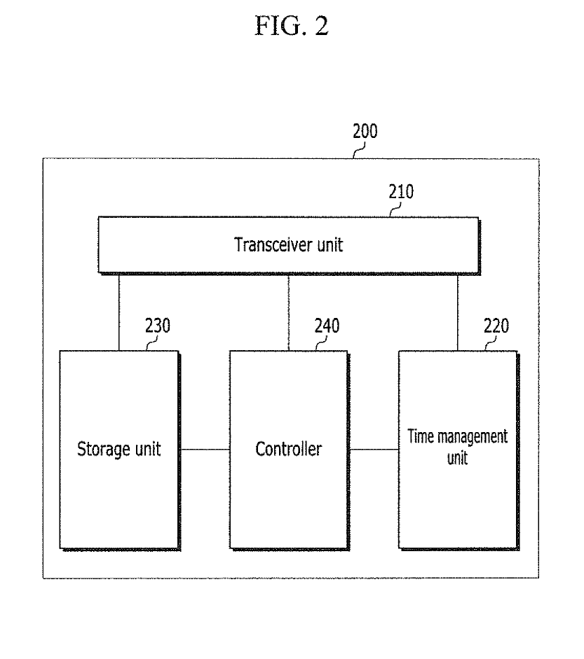

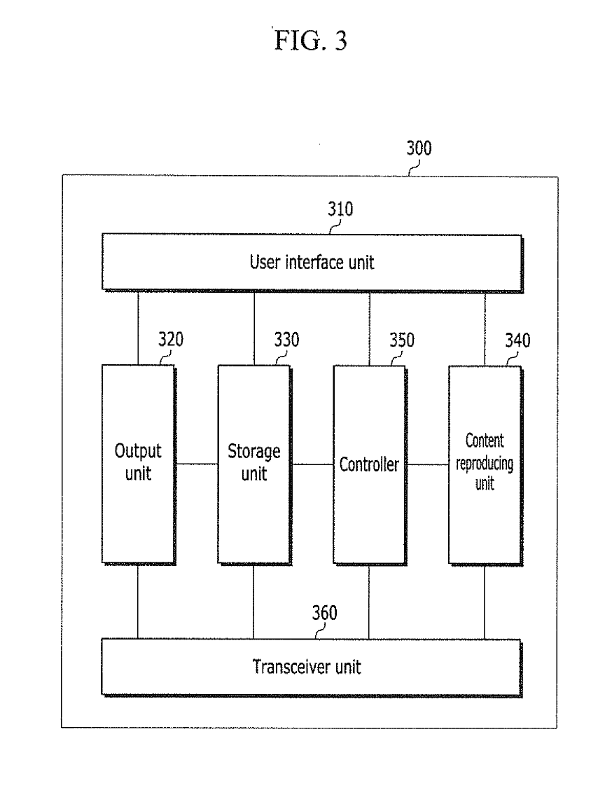

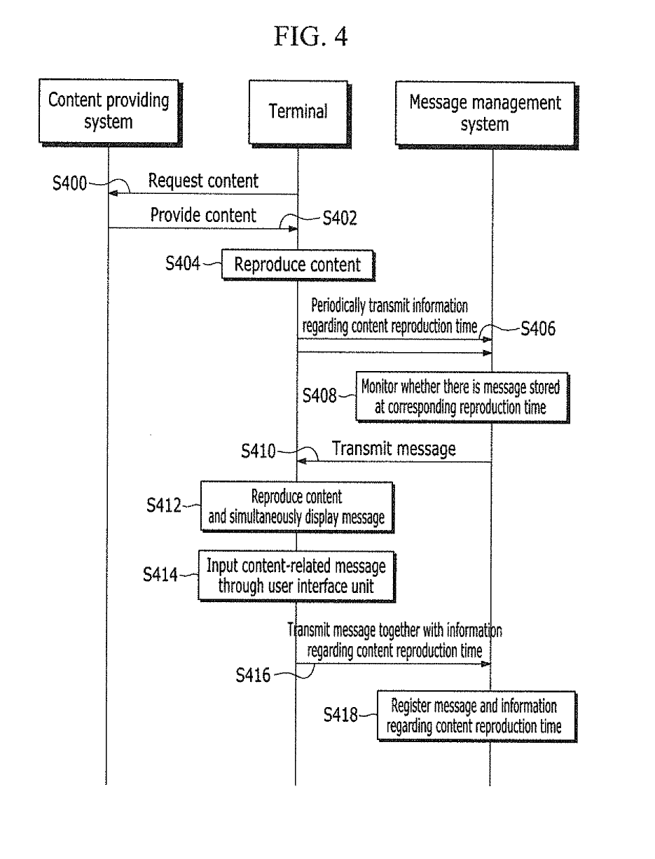

FIG. 2 is a block diagram illustrating a message management system according to an exemplary embodiment of the present invention. FIG. 3 is a block diagram illustrating a terminal according to an exemplary embodiment of the present invention. FIG. 4 is a flow chart illustrating a method for providing content according to an exemplary embodiment of the present invention.

Referring to FIG. 2, the message management system 200 includes a transceiver unit 210, a content reproduction time management unit 220, a storage unit 230, and a controller 240.

The transceiver unit 210 transmits and receives data to and from the content providing system 100 or the terminal 200. For example, the transceiver unit 210 may receive time information of content or a content-related message from the terminal 100 or transmit a content-related message stored in the message management system 200 to the terminal 100.

The time management unit 220 monitors the time information of the content received from the terminal 100, and searches whether there is a content-related message stored in the message management system 200 with respect to a predetermined time region.

The storage unit 230 receives the content-related message and the time information of the content corresponding thereto.

The controller 240 controls a general operation of the message management system 200.

Referring to FIG. 3, the terminal 300 includes a user interface unit 310, an output unit 320, a storage unit 330, a content reproducing unit 340, a controller 350, and a transceiver unit 360.

The user interface unit 310 may receive information for controlling an operation of the terminal 300 or a content-related message from the user. The user interface unit 310 may be implemented as a key pad, a dome switch, a touch pad (resistive type/capacitive type), a jog wheel, a jog switch, a microphone, a keyboard, a mouse, a remote controller, and the like.

The output unit 320 displays information processed in the terminal 300 as various types of signal (e.g., an audio signal or a video signal) to the user. The output unit 320 may be implemented as, for example, a liquid crystal display (LCD), a light emitting diode (LED), an organic light emitting diode (OLED), a speaker, and the like. For example, the output unit 320 may be a screen displaying reproduced content. According to an exemplary embodiment of the present invention, the screen of the terminal 300 may be composed of a plurality of frames. Namely, the screen of the terminal 300 may be composed of a frame in which reproduced content is displayed, a frame in which a content-related message input by the user is displayed, a frame in which a content-related message received from the message management system 200 is displayed, and the like.

The storage unit 330 may store a program for an operation of the terminal 300, and temporarily store input/output data.

The content reproducing unit 340 reproduces content received from the content providing system 100. The content reproducing unit 340 may be implemented as, for example, a video player.

The controller 350 controls a general operation of the terminal 300.

The transceiver unit 360 includes a communication module, and receives content from the content providing system 100 or transmits or receives a content-related message to and from the message management system 200. For example, the transceiver unit 360 may transmit time information of content or a content-related message to the message management system 200, or may receive a content-related message from the message management system 200.

Referring to FIGS. 2 to 4, the terminal 300 requests content from the content providing system 100 (S400). To this end, the terminal may transmit a content request message including terminal identification information and content identification information to the content providing system 100.

In a case in which the corresponding content is available in the content providing system 100, the content providing system 100 provides the corresponding content to the terminal 300 (S402). The content may be provided in a streaming manner or in a download manner.

The terminal 300 reproduces the content received from the content providing system 100 (S404). To this end, the terminal 300 may execute the content reproducing unit 340 and display the content through the output unit 320. Here, the reproduced content may be displayed on a portion of the output unit 320, e.g., the screen of the terminal 300.

Meanwhile, while the content is being reproduced, the terminal 300 periodically transmits time information of the content to the message management system 200 (S406). The time information of the content may be indicated as at least one of an hour unit, a minute unit, and a second unit, starting from a start point of the content, for example. The time information of the content may be indicated as a time region divided at every predetermined interval. For example, in a case in which a total reproduction time of the content is 120 minutes, the total reproduction time may be divided at the interval of 1 minute, and 0 minute to 1 minute, 1 minute to 2 minutes, 2 minutes to 3 minutes, . . . , 110 minutes to 120 minutes may be represented as a time region 1, a time region 2, a time region 3, . . . , and a time region 120, respectively. Here, the terminal 300 may transmit the content identification information and the terminal identification information together.

In response to the time information of the content received from the terminal 300, the message management system 200 monitors whether there is a stored content-related message (S408). To this end, the time management unit 220 may continuously observe the time information of the content received via the transceiver unit 210, and monitor whether there is a content-related message stored in the storage unit 230 corresponding to the time. Here, the content-related message may refer to various messages regarding content which was transmitted from a different terminal, which had previously reproduced the content, and stored in the storage unit 230 in advance.

Here, the message management system 200 may search a content-related message stored to correspond to a region obtained by adding a predetermined time before and after the time information of the content received from the terminal 300. For example, in a case in which time information of content is represented as a time after X minutes and Y seconds since a content start time, the message management system 200 may search a content-related message stored with respect to the region of X minutes and Y seconds±α seconds. Here, α may vary according to a setting. In a case in which time information of content is represented as a time region, a content-related message stored with respect to the same time region may be searched.

In a case in which there is a content-related message, the message management system 200 transmits the content-related message to the terminal 300 (S410), and the terminal 300 reproduces the content and simultaneously displays the content-related message received from the message management system 200 (S412).

Meanwhile, while the content is being reproduced, the user may have a question on the corresponding content or may answer to a content-related message of a different user displayed on the screen. In this case, the user may input a content-related message through the user interface unit 310.

In the case in which the content-related message is received through the user interface unit 310 (S414), the terminal 300 transmits the received content-related message, together with the time information of the content, to the message management system 200 (S416). Here, the terminal 300 may transmit terminal identification information and content identification information together.

The message management system 200 registers the content-related message and the time information of the content received from the terminal 300 (S418). To this end, the storage unit 230 of the message management system 200 may make a list of content-related messages by content, and store the same. The lists may be arranged according to order of time information. The lists may also include identification information of the terminal 300 that has transmitted the content-related message.

Hereinafter, a process of transmitting and receiving a content-related message by the terminal and the message management system will be described in more detail.

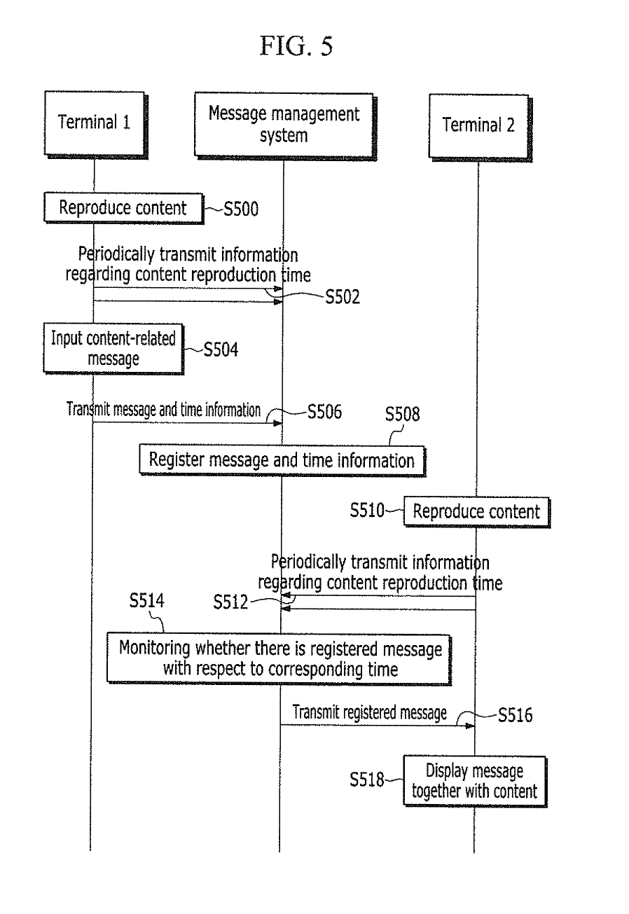

FIG. 5 is a flow chart illustrating a method for managing content-related message by the message management system according to an exemplary embodiment of the present invention.

Referring to FIG. 5, while a terminal 1 is reproducing content (S500), the terminal 1 periodically transmits time information of the content to the message management system (S502).

When the terminal 1 receives the content-related message through a user interface unit (S504), the terminal 1 transmits time information at which the content-related message was received, together with the corresponding message, to the message management system (S506). Here, the terminal 1 may further transmit terminal identification information and content identification information. The terminal identification information may be a MAC address of the terminal or a previously registered user ID. The content-related message may be a query with respect to substance of the corresponding content. For example, in a case in which the content is a video lecture, the content-related message may be a query message such as “Does any one explain the part more specifically?”, or the like.

The message management system registers the content-related message and the time information received from the terminal 1 (S508).

Meanwhile, while a terminal 2 is reproducing content (S510), the terminal 2 may periodically transmit time information of the content to the message management system (S512). Here, the terminal 2 may further transmit content identification information.

The message management system monitors whether there is content-related message which was registered at a corresponding time (S514). For example, in a case in which the time information of content received from the terminal 2 is information of a minute unit or a second unit, the message management system may search whether there is a content-related message registered by a different terminal to correspond to a time within ±α of the corresponding time. When the time information of the content received from the terminal 2 is a time region, the message management system may search whether there is a content-related message registered by a different terminal to correspond to the corresponding time region.

When there is a registered content-related message, the message management system transmits the corresponding message to the terminal 2 (S516), and the terminal 2 displays the content-related message together with the content (S518). For example, the terminal 2 may display a content-related message “Does any one explain the part more specifically?” registered by the terminal 1 in operation S508.

Although not shown, in a case in which a user of the terminal 2 wants to answer, the user of the second terminal may input a content-related message (e.g., an answer to the query) through a user interface unit and the terminal 2 may transmit the content-related message to the message management system. In a case in which the terminal 1 reproduces the same content again later or in a case in which a different terminal reproduces the same content, the message management system may transmit all of the query and answer messages to terminals that reproduce the same content.

In this manner, the message management system may store the content-related message transmitted from the terminal that reproduces the content together with the time information of the content, and may transmit a previously stored content-related message to the terminal that reproduces the same content, on the basis of the time information of the content. Thus, several users may share opinions over the same content.

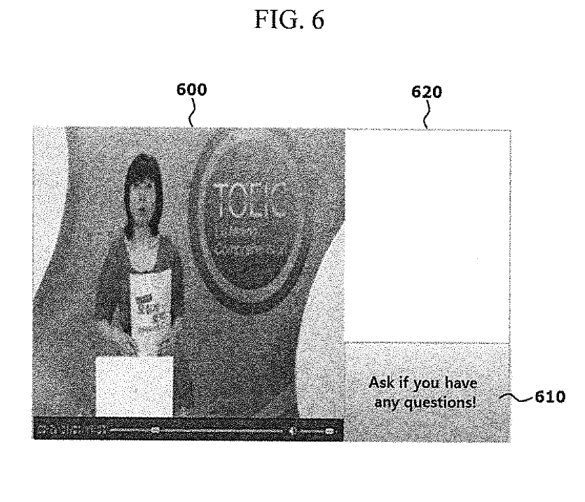

FIGS. 6 through 9 are views illustrating an example specifically implementing a method for reproducing content by a terminal according to an exemplary embodiment of the present invention.

As illustrated in FIG. 6, a screen of a terminal is divided into three frames. Namely, the screen of the terminal may be divided into a frame 600 for reproducing content (which may be mixedly used with a frame for displaying video), a frame 610 for inputting a content-related message (which may be mixedly used with a frame for creating a posting), and a frame 620 for outputting a content-related message (which may be mixedly used with a frame for displaying a posting).

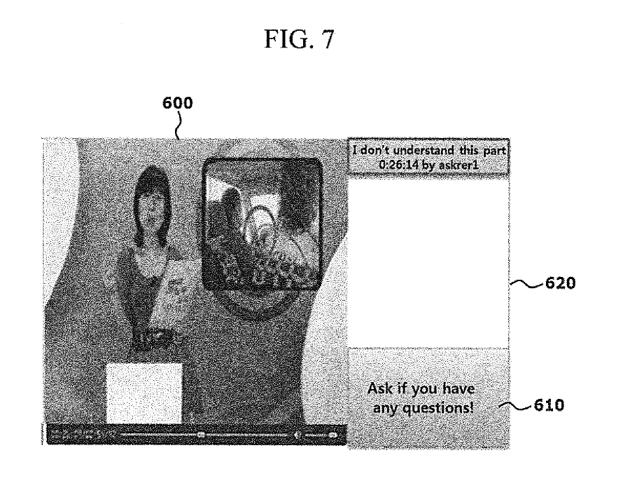

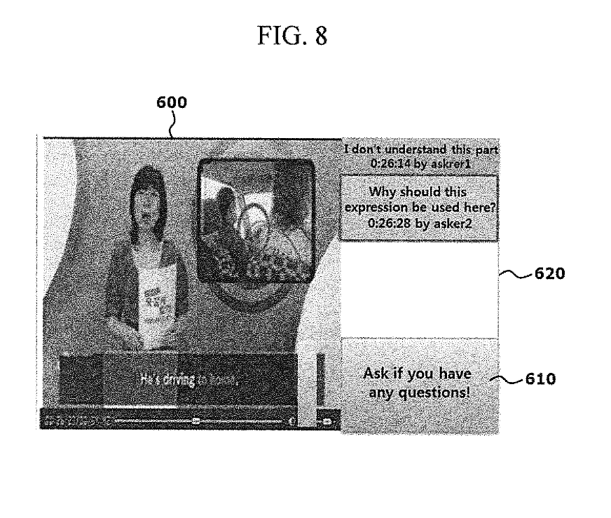

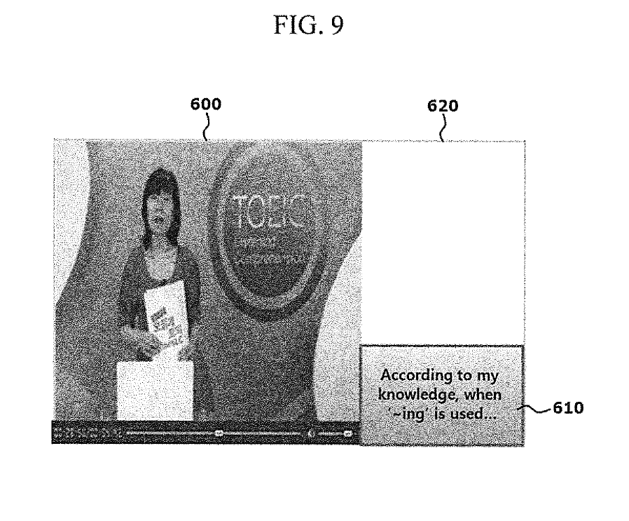

In a case which the terminal receives a content-related message from the message management system, the terminal outputs the content-related message through the frame 620 for outputting a content-related message of the screen as illustrated in FIGS. 7 and 8. When the user inputs a content-related message, the terminal outputs the content-related message input by the user through the frame 610 for inputting a message of the screen as illustrated in FIG. 9.

The terminal, the method for reproducing content thereof, the message management system, and the method for managing a content-related message thereof according to exemplary embodiments of the present invention may be variously applied to a video lecture, a smart TV, video on demand (VOID) services, and the like,

In case of application to a video lecture, structures may ask a question, answer to a question, or have a discussion over the substance of the video lecture, while listening to the video lecture. Thus, even in the video lecture, two-way interactions can be made, complementing shortcomings of a video lecture.

In case of application to a smart TV, viewers may post a review with respect to a broadcasting program or have a discussion thereover, and service providers may provide an advertisement fitting a corresponding screen.

The exemplary embodiments of the present invention may not necessarily be implemented only through the foregoing devices and/or methods but may also be implemented through a program for realizing functions corresponding to the configurations of the embodiments of the present invention, a recording medium including the program, or the like.

1. A method for reproducing content by a terminal, the method comprising:
reproducing content received from a content providing system;
receiving a first message through a user interface of the terminal while the content is being reproduced; and
transmitting time information of the content at which the first message was input and the first message to a message management system.

2. The method of claim 1, further comprising:
transmitting the time information of the content to the message management system at every predetermined period.

3. The method of claim 1, further comprising:
receiving a second message input through a different terminal through the message management system; and
displaying the second message together with the content according to time information of content corresponding to the second message.

4. The method of claim 1, further comprising:
transmitting identification information of the terminal or identification information of the content to the message management system.

5. A method for providing a content-related message by a message management system, the method comprising:
receiving a first message regarding content input in a first time region from a first terminal that reproduces the content;
storing the first message and information regarding the first time region;
receiving information regarding a time region of content at predetermined periods from a second terminal that reproduces the content; and
when the time region corresponds to the first time region, transmitting the first message to the second terminal.

6. The method of claim 5, further comprising:
of claim 5, wherein:
receiving a second message regarding the content input in the second time region from the second terminal;
storing the second message and information regarding the second time region;
receiving information regarding a time region of content at predetermined periods from the first terminal or a third terminal that reproduces the content; and
when the time region corresponds to the second time region, transmitting the second message to the first terminal or the third terminal.

7. A terminal comprising:
a content reproducing unit configured to reproduce content received from a content providing system;
a user interface unit configured to receive a first message regarding the content from a user, while the content is being reproduced; and
a transceiver unit configured to transmit time information of the content at which the first message was input and the first message to a message management system.

8. The terminal of claim 7, wherein the transceiver unit transmits the time information of the content to the message management system at every predetermined period.

9. The terminal of claim 8, wherein
the transceiver unit receives a second message input through a different terminal from the message management system,
wherein the terminal further comprises an output unit configured to display the second message together with the content according to the time information of the content corresponding to the second message.

10. The terminal of claim 9, wherein the output unit comprises at least one of a first frame displaying the content, a second frame displaying the first message, and a third frame displaying the second message.

11. A message management system comprising:
a transceiver unit configured to receive a first message regarding content from a first terminal that reproduces the content, transmit the first message to a second terminal that reproduces the content, and periodically receive time information of the content from the first terminal or the second terminal;
a storage unit configured to store the first message and time information of the content corresponding to the first message; and
a time management unit configured to monitor the periodically received time information of the content, and set the first message to be transmitted to the second terminal in a case in which the time information of the content received from the second terminal corresponds to time information of the first message received from the first terminal.

12. The message management system of claim 11, wherein the storage unit stores at least one message as a list by content.

13. The message management system of claim 12, wherein the lists are arranged in order of time information of the content.
